(19) United States
(12) Patent Application Publication
(10) Pub. No.: US 2024/0121570 A1
(43) Pub. Date: Apr. 11, 2024

(54) Apparatus, Methods and Computer Programs for Enabling Audio Rendering

(71) Applicant: Nokia Technologies Oy, Espoo (FI)

(72) Inventors: Antti Johannes ERONEN, Tampere (FI); Francesco CRICRI, Tampere (FI)

(21) Appl. No.: 18/275,238

(22) PCT Filed: Jan. 18, 2022
(86) PCT No.: PCT/FI2022/050031

§ 371 Date: Aug. 1, 2023

(30) Foreign Application Priority Data
Feb. 5, 2021 (GB) 2101657.1

(51) Int. Cl. H04S 7/00; G06N 3/08

(52) U.S. Cl. CPC H04S 7/304; G06N 3/08

(57) ABSTRACT

Example apparatus include circuitry for: obtaining audio content representing at least one audio space; enabling at least one digital signal processing operation to render the audio content such that the rendered audio content includes at least one target response for the at least one audio space wherein the enabling of the at least one digital signal processing operation to render the audio content is controlled based on obtaining the at least one target response for the at least one audio space. When the obtained target response is known the circuitry obtains at least one parameter for the at least one digital signal processing operation. When the obtained target response is unknown the circuitry obtains at least one parameter for a neural network and determines at least one parameter for the at least one digital signal processing operation.

### TECHNOLOGICAL FIELD

Examples of the disclosure relate to apparatus, methods and computer programs for enabling spatial audio rendering. Some relate to apparatus, methods and computer programs for enabling spatial audio rendering that can accommodate movement of a user.

### BACKGROUND

When a rendering device is being used to provide acoustics for mediated reality it renders acoustic effects so as to provide spatial audio for a user. In some examples the rendering device can render the spatial audio so that the user can perceive different spatial audio effects at different position with a mediated reality environment. If a user is moving in the environment then the rendering device can update the digital signal processing operations used for rendering the audio effects to enable the correct acoustic effects to be provided to the user. If the updating of the digital signal processing operations is too slow then this can reduce the accuracy of the spatial audio effects.

### BRIEF SUMMARY

According to various, but not necessarily all, examples of the disclosure there may be provided an apparatus comprising means for: obtaining audio content representing at least one audio space; enabling at least one digital signal processing operation to render the audio content such that the rendered audio content comprises at least one target response for the at least one audio space wherein the enabling of the at least one digital signal processing operation to render the audio content is controlled based on; obtaining the at least one target response for the at least one audio space; and obtaining at least one parameter for the at least one digital signal processing operation, when the obtained target response is known, and using the obtained at least one parameter to enable the at least one digital signal processing operation to reproduce an acoustic effect with the target response for a user position within the at least one audio space; or obtaining at least one parameter for a neural network when the obtained target response is unknown, and using the neural network to determine at least one parameter for the at least one digital signal processing operation, and using the at least one determined parameter to enable the at least one digital signal processing operation to reproduce an acoustic effect with the target response for the user position within the at least one audio space.

The digital signal processing operation may comprise one or more filterbanks and the at least one obtained parameter comprises one or more filterbank gains.

The filterbank may comprise means for performing any one or more of reverberator attenuation filtering, reverberator diffuse-to-direct ratio control, directivity filtering, material attenuation, medium absorption filtering.

The filterbank may comprise a graphic equalizer filterbank.

The target response may comprise target control gains for an output audio signal to enable an audio scene to be rendered to a user based on the user position within the at least one audio space.

The means may be for enabling the apparatus to receive one or more acoustic effect parameters and for enabling the acoustic effect parameters and the neural network to be used to obtain the parameters for the digital signal processing operation.

The one or more acoustic effect parameters may comprise information indicative of the at least one target response for an audio signal.

The means may be for receiving one or more parameters for the neural network and using the parameters for the neural network to generate the neural network and obtain the parameters for the digital signal processing operation.

Thee one or more parameters for the neural network may be received from an encoding device.

The means may be for receiving information indicative of one or more weights for the neural network and using the information indicative of one or more weights for the neural network to adjust the neural network and using the adjusted neural network to obtain the parameters for the digital signal processing operation.

The information indicative of one or more weights for the neural network may comprise at least one of; one or more values for one or more weights of the neural network; and, one or more references to a stored set of weights for the neural network.

The means may be for updating one or more weights for the neural network and using the updated weights to adjust the neural network and using the adjusted neural network to obtain the parameters for the digital signal processing operation.

The means may be for determining a position of a user within the at least one audio space.

The means may be providing a binaural audio output.

According to various, but not necessarily all examples of the disclosure, there may be provided an audio rendering device comprising an apparatus as described herein.

According to various, but not necessarily all examples of the disclosure, there may be provided an encoding device comprising an apparatus as described herein.

According to various, but not necessarily all, examples of the disclosure there may be provided an apparatus comprising at least one processor; and at least one memory including computer program code, the at least one memory and the computer program code configured to, with the at least one processor, cause the apparatus at least to perform: obtaining audio content representing at least one audio space; enabling at least one digital signal processing operation to render the audio content such that the rendered audio content comprises at least one target response for the at least one audio space wherein the enabling of the at least one digital signal processing operation to render the audio content is controlled based on; obtaining the at least one target response for the at least one audio space; and obtaining at least one parameter for the at least one digital signal processing operation, when the obtained target response is known, and using the obtained at least one parameter to enable the at least one digital signal processing operation to reproduce an acoustic effect with the target response for a user position within the at least one audio space; or obtaining at least one parameter for a neural network when the obtained target response is unknown, and using the neural network to determine at least one parameter for the at least one digital signal processing operation, and using the at least one determined parameter to enable the at least one digital signal processing operation to reproduce an acoustic effect with the target response for the user position within the at least one audio space.

According to various, but not necessarily all, examples of the disclosure there may be provided a method comprising: obtaining audio content representing at least one audio space; enabling at least one digital signal processing operation to render the audio content such that the rendered audio content comprises at least one target response for the at least one audio space wherein the enabling of the at least one digital signal processing operation to render the audio content is controlled based on; obtaining the at least one target response for the at least one audio space; and obtaining at least one parameter for the at least one digital signal processing operation, when the obtained target response is known, and using the obtained at least one parameter to enable the at least one digital signal processing operation to reproduce an acoustic effect with the target response for a user position within the at least one audio space; or obtaining at least one parameter for a neural network when the obtained target response is unknown, and using the neural network to determine at least one parameter for the at least one digital signal processing operation, and using the at least one determined parameter to enable the at least one digital signal processing operation to reproduce an acoustic effect with the target response for the user position within the at least one audio space.

The digital signal processing operation may comprise one or more filterbanks and the at least one obtained parameter comprises one or more filterbank gains.

According to various, but not necessarily all, examples of the disclosure there may be provided a computer program comprising computer program instructions that, when executed by processing circuitry, cause: obtaining audio content representing at least one audio space; enabling at least one digital signal processing operation to render the audio content such that the rendered audio content comprises at least one target response for the at least one audio space wherein the enabling of the at least one digital signal processing operation to render the audio content is controlled based on; obtaining the at least one target response for the at least one audio; and obtaining at least one parameter for the at least one digital signal processing operation, when the obtained target response is known, and using the obtained at least one parameter to enable the at least one digital signal processing operation to reproduce an acoustic effect with the target response for a user position within the at least one audio space; or obtaining at least one parameter for a neural network when the obtained target response is unknown, and using the neural network to determine at least one parameter for the at least one digital signal processing operation, and using the at least one determined parameter to enable the at least one digital signal processing operation to reproduce an acoustic effect with the target response for the user position within the at least one audio space.

The digital signal processing operation may comprise one or more filterbanks and the at least one obtained parameter comprises one or more filterbank gains.

According to various, but not necessarily all, examples of the disclosure there may be provided an apparatus comprising means for: obtaining audio content representing at least one audio space; enabling at least one graphic equalizer filterbank to render the audio content such that the rendered audio content comprises at least one target response for the at least one audio space wherein the enabling of the at least one graphic equalizer filterbank to render the audio content is controlled based on; obtaining the at least one target response for the at least one audio space; and obtaining at least one parameter for the at least one graphic equalizer filterbank, when the obtained target response is known, and using the obtained at least one parameter to enable the at least one graphic equalizer filterbank to reproduce an acoustic effect with the target response for a user position within the at least one audio space; or obtaining at least one parameter for a neural network when the obtained target response is unknown, and using the neural network to determine at least one parameter for the at least one graphic equalizer filterbank, and using the at least one determined parameter to enable the at least one graphic equalizer filterbank to reproduce an acoustic effect with the target response for the user position within the at least one audio space.

### Definitions

mediated reality” in this document refers to a user experiencing, for example visually, a fully or partially artificial environment (a virtual space) as a virtual scene at least partially rendered by an apparatus to a user. The virtual scene is determined by a point of view (virtual position) within the virtual space. Displaying the virtual scene means providing a virtual visual scene in a form that can be perceived by the user.
“augmented reality” in this document refers to a form of mediated reality in which a user experiences a partially artificial environment (a virtual space) as a virtual scene comprising a real scene of a physical real environment (real space) supplemented by one or more visual or audio elements rendered by an apparatus to a user. The term augmented reality implies a mixed reality or hybrid reality and does not necessarily imply the degree of virtuality (vs reality) or the degree of mediality;
“virtual reality” in this document refers to a form of mediated reality in which a user experiences a fully artificial environment (a virtual visual space) as a virtual scene displayed by an apparatus to a user;
Three degrees of freedom (3DoF) describes mediated reality where the virtual position is determined by orientation only (e.g. the three degrees of three-dimensional orientation). In relation to first person perspective-mediated reality, only the user's orientation determines the virtual position.
Six degrees of freedom (6DoF) describes mediated reality where the virtual position is determined by both orientation (e.g. the three degrees of three-dimensional orientation) and location (e.g. the three degrees of three-dimensional location). In relation to first person perspective-mediated reality, both the user's orientation and the user's location in the real space determine the virtual position.
“audio space” (or “audio sound space”) refers to an arrangement of sound in a three-dimensional space. An audio space may be defined in relation to recording sounds (a recorded sound space) and in relation to rendering sounds (a rendered sound space).
“audio scene” (or “virtual sound scene”) refers to a representation of the audio space listened to from a particular point of view (position) within the audio space.
“virtual space” may mean a virtual visual space, mean an audio space or mean a combination of a virtual visual space and corresponding audio space. In some examples, the virtual space may extend horizontally up to 360° and may extend vertically up to 180°.
“virtual scene” may mean a virtual visual scene, mean an audio scene or mean a combination of a virtual visual scene and corresponding audio scene.
“Virtual position” is a position within a virtual space. It may be defined using a virtual location and/or a virtual orientation. It may be considered to be a movable ‘point of view’.

### BRIEF DESCRIPTION

Some examples will now be described with reference to the accompanying drawings in which:

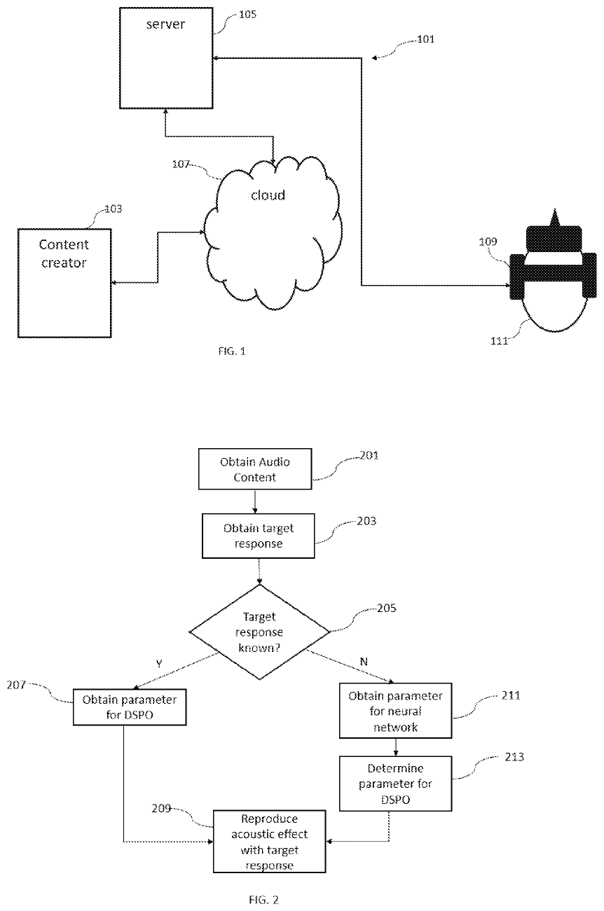

FIG. 1 shows an example system;

FIG. 2 shows an example method;

FIG. 3 shows an example feedback delay network reverberator;

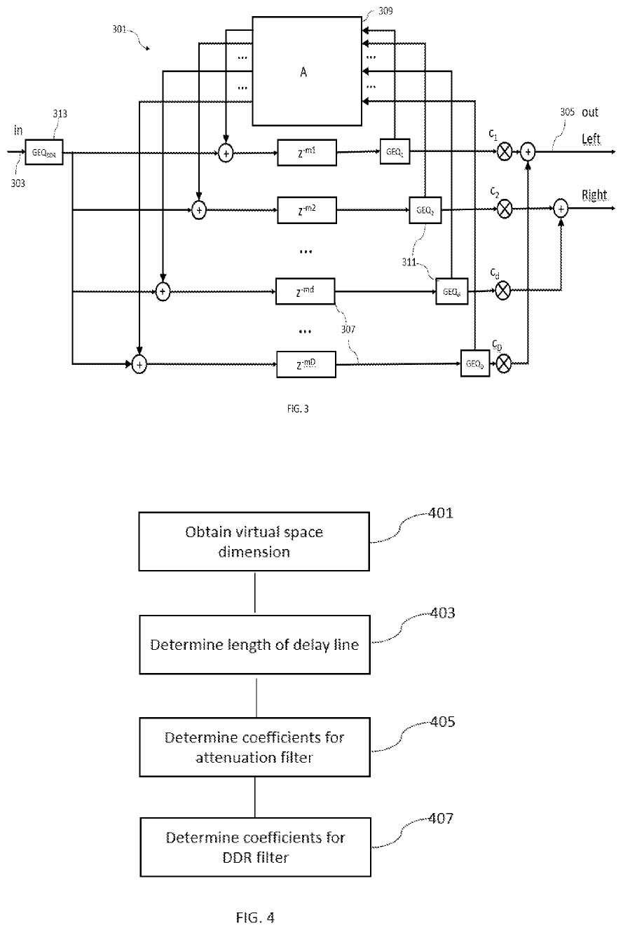

FIG. 4 shows an example method;

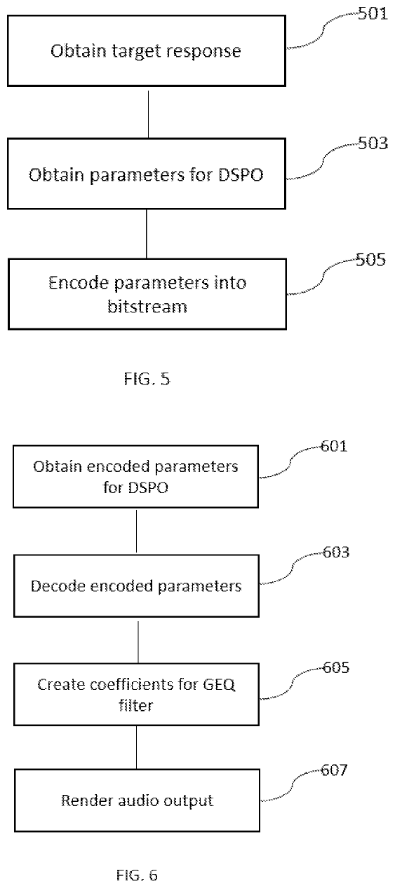

FIG. 5 shows an example method;

FIG. 6 shows an example method;

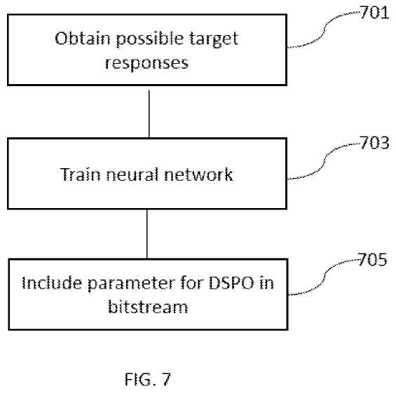

FIG. 7 shows an example method;

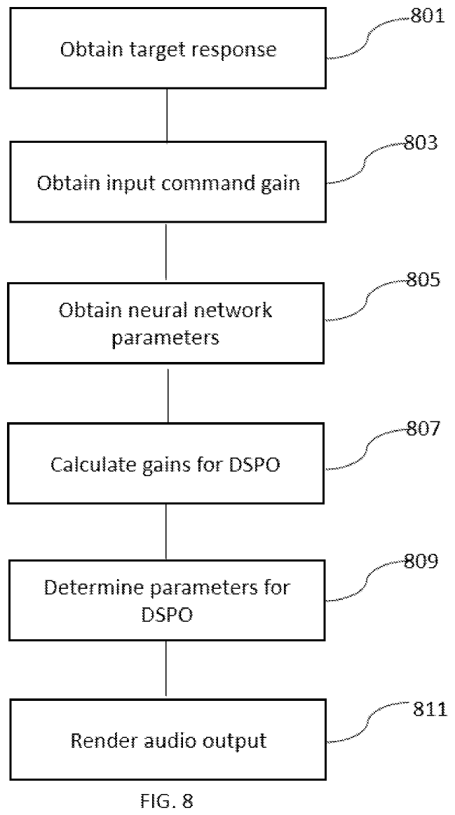

FIG. 8 shows an example method;

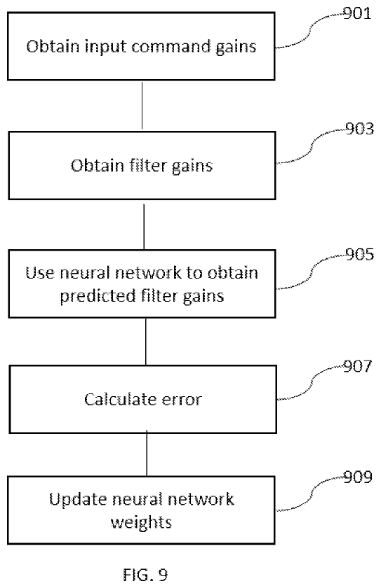

FIG. 9 shows an example method;

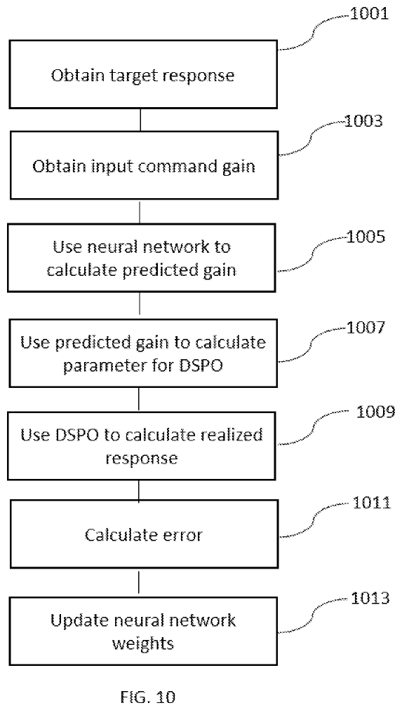

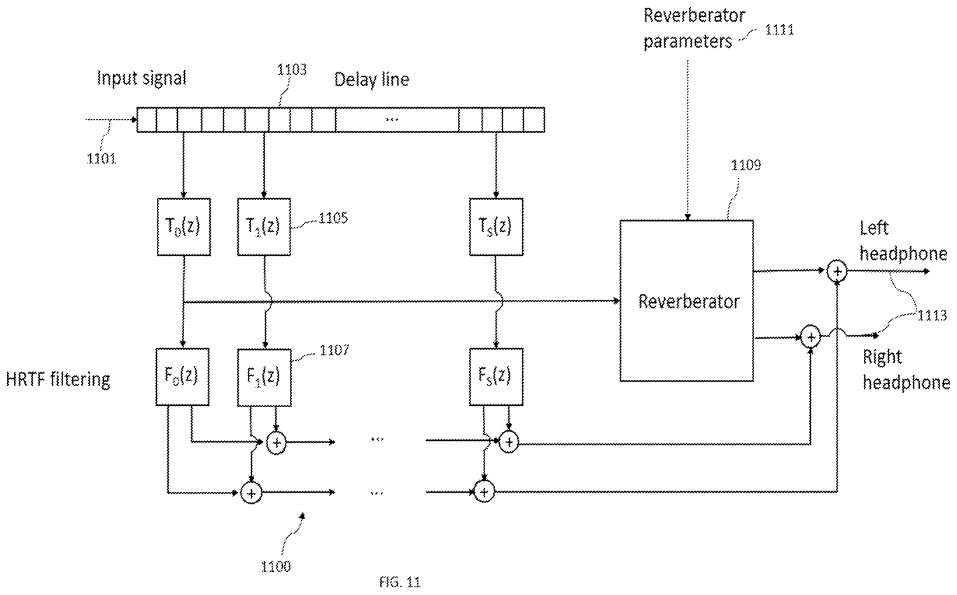

FIG. 10 shows an example method;

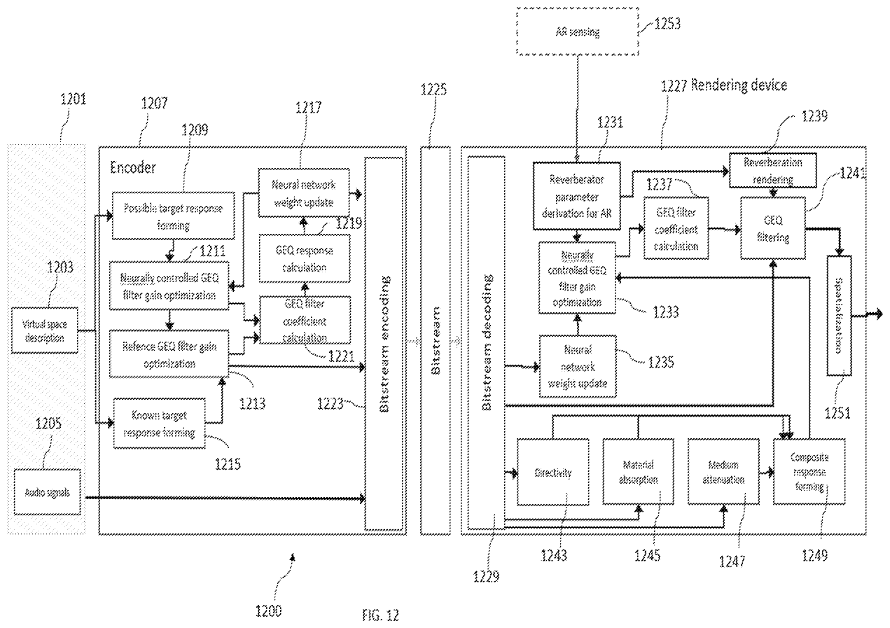

FIG. 11 shows an example rendering device;

FIG. 12 shows an example system; and

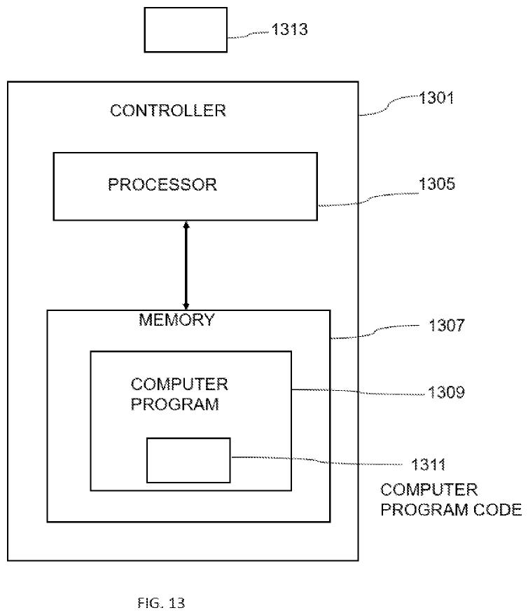

FIG. 13 shows an example apparatus.

### DETAILED DESCRIPTION

Examples of this disclosure relate to apparatus which can enable audio content to be rendered for a user. Examples of the disclosure can provide for methods of enabling one or more digital signal processing operations to be updated to enable target acoustic effects to be provided. In some examples this can enable the digital signal processing operations to be updated quickly. This can allow target acoustic effects to be changed as a user moves within a mediated reality environment. In some examples this can allow for target acoustic effects to be updated as a user moves with six degrees of freedom within a mediated reality environment.

FIG. 1 schematically shows an example system 101 that can be used to implement examples of the disclosure. The system 101 can be configured to enable mediated reality audio content to be provided to a user 111.

The system 101 comprises a content creator 103, a server 105 and a playback device 109. The content creator 103 and the server 105 are configured to communicate via a cloud network 107. It is to be appreciated that only the components of the system 101 that are referred to in the following description are shown in FIG. 1 and that other components could be provided in systems 101 in other examples of the disclosure.

The content creator 103 can comprise any means that can be configured to create content for playback to a user 111. The content creator 103 can be configured to create mediated reality content. The mediated reality content could comprise virtual reality content and/or augmented reality content or any other suitable type of content.

The content created by the content creator 103 can comprise audio content. In some examples the content created by the content creator 103 can comprise mixed media content, for example it can comprise visual content that accompanies the audio content.

In some examples the content creator 103 can be configured to generate the content by using one or more capturing means. For example, one or more microphones can be configured to capture and enable recording of audio content and one or more cameras can be configured to capture and enable recording of visual content. In some examples the content creator 103 can be configured to generate synthetic or artificial content. In some examples the synthetic or artificial content can be added to the captured content, for example animations can be added to captured images to generate mediated reality content.

The content creator 103 can comprise an encoder. The encoder can comprise any means that enable the content to be encoded to a bitstream.

The server 105 can comprise any means for storing and/or enabling access to the content. The server 105 can be configured to enable playback devices 109 to download or stream the content.

The content creator 103 can be configured to transmit the encoded bit stream to the server 109 via the cloud 107. The cloud 107 can comprise a communications network such as a wireless communication network or any other suitable means.

The playback device 109 comprises any means that enables the content to be provided to a user 111. The playback device 109 can comprise means for playing back audio content such as loudspeakers, ear pieces or any other suitable means. In some examples the playback device 109 can comprise means for playing back a visual content such as one or more displays.

In the example system 101 of FIG. 1 the playback device 109 comprises a head mounted display. Other types of playback devices 109 could be used in other examples of the disclosure such as mobile phones, wrist watches, computers, headphones, mediated reality headsets, TVs, smart speakers or any other suitable type of device.

In the example system 101 of FIG. 1 the playback device 109 is configured to enable 6DoF rendering. The playback device 109 is configured to track the position of the user and then provide the user position to the renderer. The renderer receives the bitstream comprising the content and renders the content to the user 111 based on the user's position. If the content is augmented reality content the playback device 109 can perform scanning of the environment of the user 111 to obtain environment information. The environment information can comprise acoustic properties of the environment such as reverberation characteristics, material information or any other suitable information. The information can be obtained with any suitable means such as provided manually or by means of an automatic measurement using one or more sensor inputs. The environment information can then be provided to the renderer.

Although FIG. 1 shows a system 101 for providing mediated reality content it is to be appreciated that examples of the disclosure are not limited to such examples. Some examples of the disclosure can be used for any audio content reproduction whenever some target responses or characteristics of the audio content reproduction become known at the rendering time and some other target responses or characteristics are known at content encoding time. Furthermore although FIG. 1 shows a system 101 comprising several devices it is to be appreciated that the examples of the disclosure are not limited to such examples. Some examples of the disclosure can be used on a single playback device which performs the operations of the Content creator, server, and cloud up to a sufficient extent to be able to perform audio content reproduction. An example would be reproducing audio content stored or locally captured on the playback device.

FIG. 2 shows an example method that can be implemented in examples of the disclosure. The method could be implemented by an apparatus within a rendering device. The rendering device could be comprised within the playback device 109 as shown in the system 101 shown in FIG. 1.

The method comprises, at block 201 obtaining audio content representing at least one audio space. The audio space can comprise a three-dimensional environment in which a user 111 can move. The audio scene that is rendered for the user 111 can be determined by the position of the user 111 within the audio space. Different audio scenes can comprise different spatial effects.

In some examples the rendering apparatus can be configured to determine a position of the user 111. In some examples the rendering apparatus can comprise means for tracking the position of the user 111. For example, the rendering apparatus could comprise one or more accelerometers or other means for determining the position of the user. In some examples the rendering apparatus could comprise means for communicating with a positioning system so as to enable the rendering apparatus to receive information indicative of the position of the user 111.

In some examples the audio space can be configured so as to enable a user 111 to move within the three-dimensional environment with six degrees of freedom. This could allow a user 111 to move laterally along three different perpendicular axes (x, y, z) as well as rotate about three different perpendicular axes (roll, pitch, yaw). In such examples the position of the user 111 comprises the location of the user 111 in the three-dimensional axis and the orientation of the user 111 about the axes of rotation.

At block 203 the method comprises obtaining a target response for the audio space. The target response defines acoustic effects that are to be provided within the audio space. The target response can comprise spatial acoustic effects so that different audio scenes can be rendered for different positions of the user 111 within the audio space. The target response can comprise information that can be used by a rendering apparatus to provide the spatial audio to a user 111. The target response can comprise one or more target gains for different frequency bands, or any other suitable information that enables the spatial audio to be provided.

The target response can be provided as a spectrum such as a magnitude spectrum or power spectrum or energy spectrum or in any other suitable format. The spectrum can be provided with uniform frequency resolution or non-uniform frequency resolution. The non-uniform resolution could be on frequency bands with logarithmically distributed center frequencies. In some examples the resolution could be octave or third octave bands. In some examples only few values of the target response might be provided. In some examples only one value of the target response might be provided. In these examples the method can extrapolate values of the target response to other frequencies than the one given.

If the target response is provided in the time domain then it can be converted to the frequency domain using any suitable transform such as the Discrete Fourier Transform. An example of such a target response would be an impulse response provided in the time domain.

At block 205 it is determined whether or not the target response is known. The target response could be known by the encoder and/or by the rendering apparatus. If the target response is known this means that the values of the target response, for example, the gains of a target magnitude response on logarithmic frequency bands, are already available. If the target response is known the digital signal processing operations parameters needed to set up the digital signal processing operations so as to achieve the target response, or to at least substantially achieve the target response can also be known. If the target response is not known then neural network parameters needed to set up the digital signal processing operations so as to achieve the target response, or to at least substantially achieve the target response need to be determined.

When the target response is known, then, at block 207, at least one parameter is obtained for a digital signal processing operation. As the target response is known these digital signal processing operations parameters can be optimized, or substantially optimized, using a suitable routine such as an optimization routine for the coefficients of a digital filter bank. In some examples, the digital signal processing operations parameters could be retrieved from a memory or any other suitable storage.

The digital signal processing operations parameters that are obtained enable the digital signal processing operation to reproduce an acoustic effect with the target response for a user position within the audio space.

The digital signal processing operation can comprise any operations that can be used for processing digital signals to enable digital audio content to be rendered into a signal that can be played back to a user 111. The digital signal processing operations can enable the audio content to be rendered to provide spatial audio to a user. In such examples the digital signal processing operations enable acoustic effects to be reproduced in an output audio signal. The output audio signal can be played back to a user 111 so that the audio content is audible to the user 111.

The digital signal processing operation can comprise any operations for performing any one or more of reverberator attenuation filtering, reverberator diffuse-to-direct ratio control, directivity filtering, material attenuation, medium absorption filtering or any other suitable process.

In some examples the digital signal processing operations can comprise one or more filterbanks. In some examples the digital signal processing operations can comprise one or more graphic equalization (GEQ) filterbanks. Where the digital signal processing operations comprises one or more filterbanks the obtained digital signal processing operation parameters can comprise one or more filterbank gains.

The obtained digital signal processing operation parameters are then used, at block 209, to reproduce the acoustic effects with the target response. The acoustic effects provide the target response, or substantially the target response, for a position of the user 111 within the audio space. The position of the user 111 can be a location of the user 111 and/or a rotation of the user 111.

If it is determined that the target response is unknown, then, at block 211, at least one neural network parameter is obtained. The neural network parameter can comprise one or more weights for the neural network or any other suitable parameters that enable the neural network to be configured to determine the digital signal processing operation parameters.

The neural network parameters can comprise one or more learnable parameters of the neural network and/or one or more hyper-parameters of the neural network. The hyper-parameters comprise neural network parameters that are not learned as part of the training procedure. Instead, the hyper-parameters are set by the designer of the neural network based on the performance of the trained neural network on a validation dataset. The designer could be a human or an automated designer.

The neural network parameters can be obtained in any suitable manner. In some examples the neural network parameters can be determined by the rendering apparatus based on the target response. In other examples an encoding apparatus, or other suitable device within the system 101, can determine the neural network parameters based on the target response. These neural network parameters can then be received by the rendering apparatus in an encoded bit stream. In some examples the neural network parameters themselves could be received by the rendering apparatus. In other examples the information that is received by the rendering apparatus could comprise an indication of the neural network parameters that are to be used. For example, the information could comprise a reference to specific neural network parameters within a stored set of neural network parameters. In some examples the information that is received by the rendering apparatus could comprise an indication of an update that is to be made to one or more neural network parameters.

Once the neural network parameters are obtained the neural network is used, at block 213, to determine the digital signal processing operation parameters. The determined neural network parameters are then used, at block 209, to reproduce the acoustic effects with the target response. The acoustic effects provide the target response, or substantially the target response, for a user position within the audio space. The user position can be a user location and/or a user rotation.

Examples of the disclosure therefore provide an apparatus for rendering audio content representing audio spaces. The audio spaces could be mediated reality audio spaces such as augmented reality or virtual reality audio spaces. Some examples of the disclosure can be used for any audio content reproduction whenever some target responses or characteristics of the audio content reproduction become known at the rendering time and some other target responses or characteristics are known at content encoding time.

The apparatus enables accurate reproduction of the target effects when the target effects are known. If the target effects are not known then the apparatus can enable fast set up of the digital signal processing operation. Examples of the disclosure also enable efficient compression of target responses where the neural network parameters or updates for neural network parameters can be transmitted instead of digital signal processing operation parameters.

It is to be appreciated that the blocks shown in FIG. 2 can be combined or provided in different orders. For instance, in the example shown in FIG. 2 the blocks of obtaining the at least one target response for the at least one audio space and determining if the at least one target response is known are shown as different blocks. In examples of the disclosure this could be implemented by obtaining digital signal processing operation parameters for target responses that are known. In such examples the list of known target responses can be obtained and in addition to that the neural network parameters for deriving digital signal processing operation parameters for target responses which are known only during runtime can be obtained.

FIG. 3 shows an example feedback delay network 301 that could be used in some examples of the disclosure. The feedback delay network 301 shown in FIG. 3 comprises an input 303, a plurality of outputs 305, a plurality of delay lines 307, a feedback matrix 309 and a diffuse to direct ratio (DDR) filter 313.

In the example of FIG. 3 the feedback delay network (FDN) 301 is a digital reverberator. The feedback delay network 301 is configured to add reverberation effects to an input 303. This enables the feedback delay network 301 to be used to add reverberation effects and any other target responses to an audio input signal. The feedback delay network 301 is an example digital signal processing operation that can be used to reproduce an acoustic effect with a target response corresponding to a user position. For example, the parameters of the feedback delay network 301 can be adjusted such that the feedback delay network 301 can be used to add diffuse reverberation effects to a sound source corresponding to a virtual or physical space in which the user 111 is positioned so that the user can perceive audio reproduction that matches, or substantially matches, the characteristics of the corresponding virtual or physical space. Other digital signal processing operations can be used in other examples of the disclosure.

In the example of FIG. 3 the input 303 of the feedback delay network 301 comprises an audio signal. The audio signal comprises audio content that represents an audio space. The input audio signal to the reverberator can represent a sum or mixture of sound sources which are currently active in the audio space. It is to be appreciated that this is not limited to sound sources which are currently located within the audio space but can also comprise sound sources which are outside the audio space but are audible within the audio space and thus need reverberation processing according to the audio space characteristics.

The input audio signal is provided to the DDR filter 313. The DDR filter 313 can comprise any means that can be configured to attenuate or amplity the signal in a frequency dependent manner. The example feedback delay network 301 of FIG. 3 comprises one DDR filter 313. Other numbers of DDR filters 313 could be used in other examples of the disclosure.

In the example of FIG. 3 the DDR filter 313 comprises a graphic equalization (GEQ) filter. Other types of filters could be used in other examples of the disclosure.

The feedback delay network 301 comprises D delay lines 307. The delay lines 307 can comprise any means for introducing a delay into the input signal. The delay lines 307 have lengths m1 through mD. Each delay line 307 can have a different length. In this example each delay line 307 comprises an attenuation filter 311. In this example the attenuation filters 111 comprise GEQ filters. Other types of filters and/or other types of digital signal processing operations could be used in other examples of the disclosure.

The feedback delay network 301 is configured so that output of the delay lines 307 is mixed and returned back to the recirculation through the feedback matrix 309.

The feedback delay network 301 can comprise any suitable number of delay lines 307. The number of delay lines 307 that are used can depend on the quality of the target response that is needed. In some examples the number of delay lines that are used can be selected based on a compromise between reverberation quality and computational complexity and/or based on any other suitable factors. In some examples, an efficient implementation with D=15 delay lines can be used.

The feedback matrix A can be selected so that without the attenuation filters and coefficients in the feedback loop the recirculating structure is lossless. This allows using the attenuation filters to adjust the reverberation time accurately. For example, the feedback matrix can be a circulant matrix. In some examples, the circulant matrix values are selected such that its eigenvalues are within the unit circle. One way to accomplish this is to use Galois sequences for the first row of a circulant feedback matrix. Alternative choices include using unitary feedback matrices, for example, ones comprising of unitary blocks. Yet another choice is to use Hadamard matrices.

The outputs of the delay lines 307 are added together to provide a spatial audio output 305. In this example the spatial audio output comprises a binaural audio output and so comprises a left output and a right output. The left output can be provided to a left earpiece and the right output can be provided to a right earpiece. Other types of output can be provided in other examples of the disclosure. For example, all the outputs of the delay lines can be provided as outputs of the digital reverberator and spatialized to different spatial positions around the user.

For example, the reverberator outputs can be given uniformly distributed spatial positions on the horizontal plane around the user, such as the azimuth angles 96, −72, 120, −48, 144, −24, 168, 0, −168, 24, −144, 48, −120, 72, and −96 degrees.

In order to use the feedback delay network 301 for reproducing acoustic effects with the target responses the feedback delay network 301 has to be set up with the appropriate digital signal processing operation parameters. These digital signal processing operation parameters can comprise the coefficients of each attenuation filter 311, coefficients A for the feedback matrix 309, lengths m_{d} for D delay lines 307, or any other suitable parameters. In some examples direct-to-reverberant ratio filter GEQ coefficients can also be used. In this example, the attenuation filters 311 comprise GEQ filters using M biquad Infinite Impulse Response (IIR) band filters. In examples with octave bands M=10 the parameters used for GEQ comprise the feedforward and feedback coefficients for 10 biquad IIR filters, the gains for the biquad band filters, and the overall gain.

FIG. 4 shows an example method that can be used to determine one or more digital signal processing operation parameters. This example method could be used to determine digital signal processing operation parameters for the feedback delay network 301 as shown in FIG. 3 or for any other suitable type of digital signal processing operation.

At block 401 the method comprises obtaining one or more dimensions from the geometry of a mediated reality space. The dimension could be an indication of the size of a mediated reality space. In some examples the dimension could comprise the size of a virtual area, for example it could be the size of a virtual room. In some examples the dimension could be the size of the real room in which the user 111 is positioned. This could be used for augmented reality content.

In some examples the virtual room could be shaped as a rectangular prism or cuboid. In such examples the size of the room can be defined by three perpendicular dimensions, xDim, yDim, zDim. If the room or area has an irregular shape then the dimensions of the room can be approximated using any suitable method. In some examples the dimensions could be approximated by fitting a rectangular prism or cuboid into the room and using that rectangular prism or cuboid to determine the dimensions. In other examples the dimensions could be obtained as the three longest dimensions for the room. In some examples the dimensions can be obtained as approximations of the distance traveled by a sound wave in various directions of the room before it would reach the user 111.

At block 403 the method comprises determining the length of at least one of the delay lines 307. The lengths of the delay lines 307 can be determined based on the one or more dimensions that are determined at block 401. The lengths of the delay lines 307 can be set according to standing wave resonance frequencies in the virtual room or real room having the one or more dimensions. If we define possible room modes as
roomModes=[
   [1,0,0]
   [0,2,1]
   [1,0,1]
   [2,1,0]
   [0,1,1]
   [1,1,1]
   [1,1,0]
   [0,1,2]
   [1,2,1]
   [1,2,0]
   [0,0,1]
   [2,1,1]
   [0,1,0]
   [1,0,2]
   [2,0,1]
   ];
we can use the following pseudocode to calculate the delay line length an d
for delay line d:

xMode=roomModes(d,1)/xDim;

yMode=roomModes(d,2)/yDim;

zMode=roomModes(d,3)/zDim;

xMode=xMode*xMode;

yMode=yMode*yMode;

zMode=zMode*zMode;

resonanceFreq=0.5*speedOfSound*sqrt(xMode+yMode+zMode);

m_{d}=samplingRate*1/resonanceFreq;
where speedOfSound is the speed of sound in m/s\hat{ }2 (e.g. 343 m/s\hat{ }2) and samplingRate the sampling rate in Hz (e.g. 48000 Hz). sqrt denotes the square root.

In some examples the lengths of the delay lines 307 can be set so that they are mutually prime. The delay line lengths produced from the above procedure can be, for example, further processed so that they are converted to be equal to the nearest prime number.

At block 405 the method comprises determining the coefficients for at least one of the attenuation filters 311 in the delay lines 307. The coefficients for the attenuation filters 311 can be determined based on the target responses for the audio content. For example, it can be determined based on the desired reverberation characteristics for a virtual space. In some examples the coefficients for the attenuation filters 311 can be determined so that a target amount of decibels of attenuation happens for each signal recirculation through the delay lines 307. This can enable a target RT60 time to be obtained. The RT60 indicates the time the sound pressure level takes to decrease by 60 dB, after a sound source is abruptly switched off.

The attenuation of the signals can be applied in a frequency specific manner. Applying the attenuation in a frequency specific manner can ensure that the appropriate rate of decay of signal energy at specified frequencies is obtained.

In such examples information indicative of the target desired RT60 times for specified frequencies f denoted as rt60(f) in seconds can be provided as an input to an encoding device or any other suitable device within a system 100. For a frequency f, the desired attenuation per signal sample can be calculated as attenuationPerSample(f)=−60/(samplingRate*rt60(f)), where samplingRate is the signal sampling rate in Hz. The attenuation in decibels for a delay line 307 of length an d is then attenuationDb(f)=md*attenuationPerSample(f).

At block 407 the method also comprises determining coefficients for the DDR filter 313. The coefficients for the DDR filter 313 can be determined based on the target diffuse-to-direct ratio characteristics for the mediated reality space. The diffuse-to-direct ratio characteristics can be provided as a frequency dependent target response, which indicates the amount of diffuse sound energy at the given frequencies. The DDR filter parameters can be adjusted so that when the reverberator is fed with a unit impulse, the reverberator output follows the target response provided in the diffuse-to-direct ratio characteristics. This can be done by first disabling the DDR filter and feeding the reverberator with a unit impulse and measuring the spectrum of the output reverberation. The DDR filter target response can then be taken as the difference between the target diffuse-to-direct ratio characteristics and the spectrum of the output reverberation without a DDR filter. The diffuse-to-direct ratio characteristics can also be provided as an impulse response. In this case, the amount of direct sound energy and diffuse sound energy can be determined from the provided impulse response, and the spectrum of the diffuse sound energy can be taken as the target response. The DDR filter parameters can be designed as described above.

The example method shown in FIG. 4 could be performed by an encoding device or a rendering apparatus. For instance, if the audio content is used for virtual reality then the method can be performed by an encoding device whereas if the audio content is used for augmented reality the method can be performed by a rendering apparatus. In examples where the method is performed by an encoding device the determined digital signal processing operation parameters can be encoded to a bit stream and transmitted to a rendering apparatus. In examples where the method is performed by the rendering apparatus the rendering apparatus can receive information indicative of the virtual space from the encoding device or from any other suitable device.

It is to be appreciated that the digital signal processing operation parameters that are to be obtained can be determined by the type of digital signal processing operation that is used. In the example of FIG. 3 the digital signal processing operation comprises attenuation filters 311 and DDR filters 313 and so the digital signal processing operation parameters that are obtained comprise the coefficients for these filters 311, 313 as described in relation to FIG. 4.

In some examples the attenuation filters 313 can be designed as cascade GEQ filters for each delay line 307. The procedure for designing the filters has a set of command gains at octave bands as an input. In other examples third octave bands could be used instead of octave bands. This could increase the number of biquad filters that are used and could provide better matches for detailed target response. The set of command gains can be pre-processed before the coefficients for the GEQ filters can be optimized or substantially optimized. In some examples each frequency f of the input target response can be mapped to the closest octave band. The mean attenuation in decibels can then be subtracted from the target response and combined to the overall GEQ gain. This can be used to limit the range of control gains that need to be approximated with the response of the GEQ filter.

In some examples the selection between octave and third octave GEQ filters can be dynamic. In such examples, if the method has been configured to use third octave GEQ filters but the RT60 input data does not provide enough samples then the input data is interpolated to octave GEQ filters.

In some examples the method can be configured to enable lowering of the GEQ frequency resolution from third octave to octave bands. In such examples the method can comprise determining whether or not the input response would benefit from the third octave resolution. Determining whether or not the input response would benefit from the third octave resolution could comprise inspecting whether or not adjacent input frequency samples map to different third octave bands. For example, at least six adjacent input frequency samples could be inspected to determine whether or not they map to different third octave bands. If the frequency samples do not map to different third octave bands then it can be inferred that there is no benefit from the third octave resolution and the method can switch to using octave band resolution instead.

Once the selection between octave and third octave filters has been made the GEQ filter coefficients can be optimized or substantially optimized. Any suitable method can be used to optimize of substantially optimize the GEQ filter coefficients. In some examples the GEQ filter coefficients could be optimised using an iterative method which can be referred as accurate cascade graphic equalizer (ACGE). In such examples the input command gains in dB g_{c}=[g_{c,1}g_{c,2} . . . g_{c,M}]^{T} are provided by the attenuation in decibels mapped to each band. The method provides optimized, or substantially optimized, GEQ filter gains in dB gₒ=[g_{o,1}g_{o,2} . . . g_{o,M}]^{T}. The optimized, or substantially optimized, GEQ filter gains in dB gₒ=[g_{o,1}g_{o,2} . . . g_{o,M}]^{T} can be encoded to a bitstream to be transmitted to a server 105 or to a rendering device as appropriate. The rendering apparatus, or any other suitable device, can use the optimized, or substantially optimized, GEQ filter gains in dB gₒ=[g_{o,1}g_{o,2} . . . g_{o,M}]^{T} to calculate the optimized, or substantially optimized GEQ filter coefficients. Any suitable processes or algorithms can be used to calculate the optimized, or substantially optimized GEQ filter coefficients. In some examples, the input command gains g_{c}=[g_{c,1}g_{c,2} . . . g_{c,M}]^{T} can be encoded into a bitstream.

The frequency response of a cascade graphic EQ can be written as

$$H ( {e}^{j ω {T}_{s}} ) = {G}_{0} {\prod }_{m = 1}^{M} {H}_{m} ( {e}^{j ω {T}_{s}} ) ,$$

where G₀ is an overall gain factor and can be set equal to 1 during optimization. H(e^{jωT}^{ₛ}) are the frequency responses of equalizing filters, ω is the radial frequency and Tₛ=1/samplingRate is the sample interval.

The corresponding amplitude response in decibels can be written as

$${A}_{c} ( {e}^{j ω {T}_{s}} ) = {g}_{0} + {\sum }_{m = 1}^{M} {A}_{m} ( {e}^{j ω {T}_{s}} )$$

$$where {g}_{0} = 20 log ( {G}_{0} ) and {A}_{m} ( {e}^{j ω {T}_{s}} ) = 20 log ( \vert {H}_{m} ( {e}^{j ω {T}_{s}} ) \vert ) .$$

It has been observed that the amplitude responses Aₘ(e^{jωT}^{ₛ}) of individual equalizing filters are similar on the decibel scale. A design principle thus can be devised where the dB amplitude responses are used as basis functions which are weighted by their respective command gain g_{c,m}.

An 2M−1 by M interaction matrix B which stores the normalized dB amplitude responses of all M filters at 2M−1 frequencies can be constructed as

B_{k,m}=Aₘ(e^{jωT}^{ₛ})/gₚ

where k=1,2,3, . . . 2M−1 and m=1,2,3, . . . M are the frequency and filter indices, respectively. The prototype dB gain common to all equalizing filters is

gₚ=20 log(Gₚ).

The optimal dB gains in the least squares sense can be obtained by using the pseudoinverse matrix B⁺

g=B⁺t₁=(B^{T}B)⁻¹B^{T}t₁

where t₁ is a 2M−1 vector whose odd rows contain the original control gain dB values and even rows contain their linearly interpolated intermediate values.

Second interaction matrix B₁ can then be defined using the gains g from above instead of the prototype gain. The amplitude responses of M band filters, which are described in more detail below, are sampled in dB to create the M columns of B₁. The band filters are initialized with the near optimum gain values G(m) and normalized with the corresponding dB gain gₘ. Optimum filter gains gₒ are then obtained from

gₒ=B₁⁺t₁=(B₁^{T}B₁)⁻¹B₁^{T}t₁

The optimum dB gains g_{o,m} are converted to linear gain factors Gₘ.

In some examples the transfer function of the GEQ filters can be written as

$${H}_{m} ( z ) = {b}_{0 , m} \frac{1 + {b}_{1 , m} {z}^{- 1} + {b}_{2 , m} {z}^{- 2}}{1 + {a}_{1 , m} {z}^{- 1} + {a}_{2 , m} {z}^{- 2}}$$

where the scaling coefficient is defined as

$${b}_{0 , m} = \frac{1 + {G}_{m} {β}_{m}}{1 + {β}_{m}}$$

Where Gₘ is the target filter gains and βₘ is defined as

$${β}_{m} = \sqrt{\frac{\vert {G}_{B , m}^{2} - 1 \vert}{\vert {G}_{m}^{2} - {G}_{B , m}^{2} \vert}} tan ( \frac{{B}_{m}}{2} )$$

When Gₘ≠1 or as

$${β}_{m} = tan ( \frac{{B}_{m}}{2} )$$

When Gₘ=1. The gain G_{B} can be set as G_{B,m}=Gₘ/2.

The numerator coefficients are

$${b}_{1 , m} = - 2 \frac{cos ( {ω}_{c , m} )}{1 + {G}_{m} {β}_{m}}$$

$${b}_{2 , m} = \frac{1 - {G}_{m} {β}_{m}}{1 + {G}_{m} {β}_{m}}$$

where cos(ω_{c,m}) is the center frequency for band m.

The denominator coefficients are

$${a}_{1 , m} = - 2 \frac{cos ( {ω}_{c , m} )}{1 + {β}_{m}}$$

$${a}_{2 , m} = \frac{1 - {β}_{m}}{1 + {β}_{m}}$$

where ω_{c,m}=2π_{c,m}/fₛ is the normalized center frequency in radians. The sampling rate is fₛ=48000 Hz.

The gain factor G₀ for the GEQ filters is the product of the scaling coefficients of the band filters

$${G}_{0} = {\prod }_{m = 1}^{M} {b}_{0 , m}$$

In some examples the apparatus can be configured to enable the structures of the filters to be changed. If the input response is constant, or substantially constant over the frequency range, then the apparatus can be configured to use a simple gain filter instead of a GEQ. If there is a large attenuation in decibels at the high frequency range, then the apparatus can be configured to add a lowpass filter, constructed for example as a cascade of second-order-section II R filters. The lowpass filter can be configured to attenuate the high frequency region so that the resulting attenuation is a closer match to the requested attenuation. In some examples the apparatus can be configured to convert the coefficients of a cascade graphic equalizer to the coefficients of a parallel graphic equalizer.

In the example shown in FIG. 3 the DDR filter 313 is also a GEQ filter. In this example the DDR filter 313 can be applied on the reverberator bus to which input signals to the diffuse reverberator are summed. The more negative the control gain of the diffuse-to-direct ratio filter at a certain frequency the more that frequency is dominated by direct sound. A diffuse-to-direct ratio DDR(f) can be provided in the encoder input format file. The diffuse-to-direct ratio DDR(f) can then be used to optimize the filter coefficients so that the control gain is zero when DDR(f)=1 and control gain is a large negative number (in decibels) when the DDR(f)=0. DDR values provided on a linear scale can be converted to decibels before applying as target response for the GEQ filter coefficient optimization. Furthermore, the difference in decibels of the DDR values (in decibels) and the reverberator response (in decibels) can be taken as the target response of the GEQ coefficient optimization.

FIG. 5 shows another example method that can be implemented in examples of the disclosure. The method of FIG. 5 comprises a method of encoding content when a target response is known. The method shown in FIG. 5 can be performed by an encoding device or by any other suitable combination of devices.

At block 501 the method comprises obtaining a target response. The target response defines acoustic effects that are to be provided within the audio space.

At block 503 the method comprises obtaining the digital signal processing operation parameters to enable the digital signal processing operation to reproduce an acoustic effect with the target response for a user position within an audio space. In some examples the digital signal processing operation could comprise a feedback delay line network 301 as shown in FIG. 3. In such examples the digital signal processing operation parameters can comprise one or more gains for filters such as attenuation filters 313, delay line lengths, positions of output channels and any other suitable parameters.

At block 505 the method comprises encoding the obtained digital signal processing operation parameters into a bitstream. The encoding can comprise any process that converts the obtained parameter values into suitable integer representations with a required number of bits and writes them as a sequence of binary values.

The example method shown in FIG. 5 could be used in implementations where the audio content is used for virtual reality applications. In such examples the target responses, such as target attenuation filter 313 responses are known since the reverberation characteristics (frequency dependent RT60 times) are available to the encoding device. In such examples the encoding device can optimize the digital signal processing operation parameters to enable the target response to be accurately reproduced. In such cases it does not matter if the optimization process is iterative and/or involves matrix inversions and takes some time.

FIG. 6 shows another example method that can be implemented in examples of the disclosure. The method shown in FIG. 6 can be implemented by a rendering apparatus. In the example of FIG. 6 the target response is known. In this example the target response is known and so the filter gains needed for the digital signal processing operations are also known.

At block 601 the method comprises obtaining the encoded filter gains or other digital signal processing operation parameters from an encoded bitstream. As described above the encoded digital signal processing operation parameters can comprise one or more gains for filters such as attenuation filters 313, delay line lengths, positions of output channels and any other suitable parameters.

At block 603 the method comprises decoding the encoded digital signal processing operation parameters. The decoding can comprise converting encoded gains and other transmitted parameters from integer format to floating point format or any other suitable decoding process.

The decoded digital signal processing operation parameters are then used, at block 605 to set up the digital signal processing operation. For example, the obtained parameters can be used to create GEQ filterbank coefficients based on the gains identified in the received digital signal processing operation parameters. In other examples the digital signal processing operation parameters could be used to create coefficients for any other suitable type of filter.

At block 607 the digital signal processing operation can be used to render an audio output using the digital signal processing operation parameters. For example, the GEQ filterbank coefficients can be used to render an audio output in which an acoustic effect with the target response is reproduced.

FIG. 7 shows an example method that can be implemented in an encoding device if the target response is unknown. The example of FIG. 7 could be used where the audio content is for augmented reality applications. In such cases the target responses for attenuation filters are unknown when the content is being encoded. The target responses for the attenuation filters are unknown and would only become available once the location of the user 111, and acoustic characteristics of the environment of the user 111 is known.

The method shown in FIG. 7 comprises, at block 701 obtaining a plurality of possible target responses. The possible target response could comprise a plurality of estimated responses that could be used.

The possible target responses can be random value combinations within a given range of supported control gain values such as +/−12 dB. In some examples the target responses can be based on combinations of different materials that could be used in the augmented reality space. In this case the possible target response can take into account different possible material combinations corresponding to different combinations of wall reflections. A composite target response can be formed by combining frequency dependent material attenuation values. In some examples the possible target responses can also combine the effect of other acoustic effects into the possible target responses. The other acoustic effects could be medium attenuation and/or directivity filtering, and/or any other suitable acoustic effects.

The control gains that are needed to reproduce the possible target responses are obtained. The possible target responses are converted to possible control gain values in dB

g_{c}=[g_{c,1}g_{c,2} . . . g_{c,M}]T

At block 703 the method comprises training a neural network to predict digital signal processing operation parameters to enable the digital signal processing operation to reproduce an acoustic effect with the target response. In some examples the neural network can be trained to predict gains for the attenuation filters 311 or other GEQ filters.

The training of the neural network enables the neural network to perform the mapping from input control gains to optimized, or substantially optimized, GEQ gains or any other suitable parameter. Details of procedures for training the neural network are provided below. The training determines one or more neural network parameters. The neural network parameters can be weights or any other suitable parameters.

At block 705 the neural network parameters are comprised within a bitstream. The neural network parameters can be encoded and/or compressed using any suitable process before they are comprised within the bitstream.

In some examples the neural network parameters can be stored in the rendering apparatus. In such examples the training of the neural network can be performed offline. The encoding device can then signal updates to the neural network parameters based on data of the augmented reality space. The neural network parameter updates can then be applied to the pre-trained neural network parameters to form updated neural network parameters. The updated neural network parameters can then be used to perform the mapping from input control gains to optimized, or substantially optimized, GEQ gains or any other suitable neural network parameter.

The data required for enabling the neural network parameters to be updated can be obtained from one or more sensing inputs of an augmented reality device or from any other suitable device. For example, a sensing input can be obtained that comprises material responses and/or reverberation attenuation filter responses for one or more real environments. The neural network parameters can then be based on an error metric between the response of a GEQ, or other digital signal processing operation, whose digital signal processing operation parameters are derived using the pre-trained neural network and the target response.

In some examples the plurality of target responses can be obtained from the bitstream. For instance, in cases where the audio content is to be used for virtual reality the target responses can be received from an encoding device, or any other suitable source, in the bitstream. Upon receiving the plurality of target responses the neural network can be optimized, or substantially optimized, so that the error between the pre-trained neural network based digital signal processing operation response and the target response is minimized, or substantially minimized.

In augmented reality cases, the acoustic characteristics, such as the desired reverberation characteristics can be provided to the renderer during run time. The reverberation characteristics or other acoustic characteristics can be provided as described above for the virtual reality examples, or using any other suitable method. However, in the augmented reality examples the acoustic characteristics are provided in runtime when the rendering apparatus is started or if the audio environment changes. The audio environment could change, for example, if a user 111 changes their location. In examples of the disclosure neural networks are used for the derivation of the digital signal processing operation parameters. The use of the neural networks provides the technical effect that the derivation of the digital signal processing operation parameters is fast to execute and avoids iterative processes such as matrix inversion.

The use of the neural networks for determining the digital signal processing operation parameters can be done for reverberation parameters for augmented reality applications because these reverberation parameters are only known during runtime. The use of the neural networks for determining the digital signal processing operation parameters can be done for other target responses which are known only during rendering for both virtual reality and augmented reality applications such as composite responses due to accumulating material responses of different wall reflections, combined with material attenuation and/or source directivity filtering.

A technical effect of the neural network methods is that they avoid iterative procedures and/or, matrix inversions which make them simple to implement on the renderer side.

FIG. 8 shows another example method according to examples of the disclosure. This method can be performed by a rendering apparatus in example of the disclosure in examples where the target response was not known when the audio content was encoded.

At block 801 the target response is obtained. The target response could be desired attenuation filter response required such as the desired attenuation filter response required for reproducing the listening room reverberation time and/or any other suitable target response. The target response can be received from a sensing input that can be configured to sense parameters of the real environment. The target response can be obtained in any suitable format.

At block 803 one or more input command gains are obtained from the target response. The input command gains can be the gains that are to be provided to the digital signal processing operation in order to enable the digital signal processing operation to reproduce an acoustic effect with substantially the target response. The input command gains can be obtained by calculating the magnitude response of the target response in decibels for frequency bands of the attenuation filters 313 or by any other suitable process.

At block 805 the method comprises obtaining one or more neural network parameters. The one or more neural network parameters can comprise one or more weights for the neural network or any other suitable parameters. The neural network can be pre-stored in the memory of the rendering apparatus or can be obtained from the bitstream.

In examples of the disclosure there can be one neural network or a plurality of neural networks. In examples where there is only a single neural network the same neural network can be used for all of the attenuation filters 313. In some examples there could be two neural networks where a first neural network could be used for octave bands and a second neural network could be used for third octave bands. In other examples there could be more than two neural networks so that different neural networks can be used for different acoustic effects such as for reverberation attenuation and material filtering.

At block 807 the neural network is set up with the obtained neural network parameters and used to determine one or more gains for the digital signal processing operation. For example, the neural network can be used to produce the optimized, or substantially optimized, filter gains gₒ based on the control gains g_{c} from the target response. At block 809, the filter gains gₒ are used to determine one or more digital signal processing operation parameters. For example, the filter gains gₒ can be used to determine the GEQ filterbank coefficients or any other suitable filter coefficients.

At block 811 the determined digital signal processing operation parameters are used to render an audio output so as to reproduce an acoustic effect with the target response.

In some examples the target response can be the summed effect of one or more combined material reflections such as medium attenuation. The material absorption coefficients can be obtained by the rendering apparatus or other part of the system. The material absorption coefficients could be obtained from one or more sensing inputs in augmented reality applications of in the bitstream in virtual reality applications. The absorption coefficients can indicate the amount of energy absorption per frequency band. When a sound is reflected from one or more different types of material, the corresponding absorption values in frequency bands are combined (for example, summed) so as to provide a combined response. In some examples, other acoustic effects on the simulated sound transmission path can be added. Other acoustic effects could comprise medium (air) absorption, acoustic occlusion, acoustic diffraction, acoustic transmission, or any other suitable effects. The other acoustic effects can be combined to provide the overall target response. The neural network can then be used to obtain optimized, or substantially optimized, filter coefficients at each audio frame for the desired target filter response.

FIG. 9 shows an example method of training neural networks that can be used in examples of the disclosure. FIG. 9 shows an example of pre-training neural networks. The pre-training of the neural networks can be performed off-line and then deployed in the rendering apparatus. The pretraining can be used to obtain a neural network that performs well for different types of situations and types of audio content. The pre-trained neural network could be further updated, where the update is obtained offline and is not specialized to a specific audio content or audio space. This update represents an improvement of the pre-trained neural network. The neural network can then be optimized further for specific situations according to the type of audio content and the audio space.

In this example the pre-training of the neural network comprises an iterative process. At each iteration, the input to the neural network is represented by one or more control gains. The output of the neural network represents the optimized control gains, from which the filter parameters, or other digital signal processing operations parameters, are then determined via closed formulas.

At block 901 the method comprises obtaining input command gains. The input command gains can be obtained as random gain combinations in the range of possible control gains or actual target responses to be modelled.

At block 903 the method comprises obtaining calculated filter gains based on the input command gains. The calculated filter gains can be obtained using an iterative reference design method, such as the ACGE method or by any other suitable process.

At block 905 the neural network is used to create predicted filter gains based on the input command gains. The predicted filter gains are created using the first weights of the neural network.

At block 907 an error between the filter gains obtained using the iterative reference design method and the predicted filter gains obtained using the neural network is calculated. In this example the target responses are assumed to be available at pretraining stage. The target responses can be obtained from the virtual scene description, as the desired responses of different acoustic effects such as material absorption or any other acoustic effects.

In examples where the computational path from the error function to the neural network is differentiable, or where gradients of the error with respect to the neural network weights can be obtained in other suitable means, the computation of the weight-update can comprise computing gradients of the error with respect to the neural network weights. The gradients of error can be computed using a back-propagation algorithm or by any other suitable means.

In examples where the computational path from the error function to the neural network is not differentiable the computation of the weight-update can comprise reinforcement learning or any other suitable means.

In some examples where the computational path from the error function to the neural network is not differentiable the computation of the weight-update can comprise replacing the non-differentiable components of the computational path with differentiable approximators of those components. The differentiable components can be components that have been determined at a previous stage. For example, another neural network can be trained to approximate the input-output response of the one or more non-differentiable components.

In some examples where the computational path from the error function to the neural network is not differentiable the computation of the weight-update can comprise performing the non-differentiable operation in the forward pass of the neural network training iteration, and using an approximation of the gradient of the non-differentiable operation in the backward pass of the backpropagation algorithm. Here, non-differentiable operations includes both operations for which it is not possible to compute gradients, and operations whose gradients are zero almost everywhere.

This error is used, at block 909, to update the neural network with a second set of weights. The weights can comprise any learnable neural network parameters. The neural network can be updated using any suitable process. In some examples the neural network can be updated using an optimization routine such as Stochastic Gradient Descent, Adam, or any other suitable routine.

The training process can comprise several iterations of weight-updates. The training process can comprise repeating blocks 905 to 907 of FIG. 9. The training process can stop when a given criterion is met. The criterion for stopping could be that the error does not decrease more than a predefined amount, that a certain time limit is over, that the error computed on a validation dataset (a different dataset with respect to the training dataset) does not decrease anymore or any other suitable criterion. Once the pretraining of the neural network has been completed the pretrained neural network can be deployed into a rendering apparatus.

FIG. 10 shows a method another method that can be used for training a neural network. The method can be used in an encoding device or it can be used for fine tuning a neural network by a rendering apparatus. Where the method is used by an encoding device the encoder is assumed to have a copy of the neural network that is available to the rendering apparatus. The method shown in FIG. 10 is similar to the method shown in FIG. 9. The method of FIG. 10 differs from the method of FIG. 9 in that it uses test-time input data rather than a large training dataset. Also, the method of FIG. 10 can use a smaller learning rate compared to the learning rate used in the pre-training methods of FIG. 9.

At block 1001 the method comprises obtaining a target response. At block 1003 the method comprises obtaining an input command gain. The input command gain can be obtained from the target response.

At block 1005 the method comprises calculating predicted filter gains based on the input command gains. The predicted filter gains are created using the first neural network parameters. The neural network parameters could be one or more weights or other learnable parameters of the neural network.

The predicted filter gains are then used, at block 1007, to calculate digital signal processing operation parameters. For example, the predicted filter gains can be used to determine coefficients for a GEQ filterbank.

At block 1009 the to calculated digital signal processing operation parameters can be used to calculate a realized response.

At block 1011 the error between the target response and the realized response obtained at block 1009 is calculated.

This error is used, at block 1013, to update the neural network with a second set of neural network parameters. The neural network can be updated using any suitable process. In some examples the neural network can be updated using an optimization routine such as Stochastic Gradient Descent, Adam, or any other suitable routine.

It is to be appreciated that not all of the neural network parameters need to be updated during the iterative training process. In some examples only a subset of the neural network parameters are updated. For example, in some cases only the bias terms of the neural network layers are updated or in some cases only the neural network parameters from the last one or more layers of the neural network are updated. Other subsets could be used in other examples of the disclosure.

In examples where the training of the neural network is performed by the encoding device then the updates to the neural network parameters are encoded into a bitstream to enable them to be provided to a rendering apparatus or other suitable device on the decoding side. The updates to the neural network parameters can be comprised within the bitstream of the encoded audio content (in-band signalling) or comprised within a separate bitstream (out-of-band signalling).

In some examples the rendering apparatus, or other apparatus on the decoder side, might not have a pretrained neural network. In such examples the encoder would provide the neural network parameters, rather than updates to the neural network parameters, in the encoded bit stream.

Any suitable process can be used to encode the neural network parameters or the updates to the neural network parameters. In some examples the encoding of the neural network parameters or the updates to the neural network parameters can comprise one or more of the following processes. However, other suitable encoding methods for neural network parameters or updates to neural network parameters can be used. These processes can decrease the bitrate required to signal the neural network parameters or updates to the neural network parameters:
Sparsify the neural network parameters or updates to the neural network parameters. Sparsifying the neural network parameters or the updates to the neural network parameters can comprise setting some of their values to zero. The values that are set to zero can be the least important values. The least important values can be the values which have less impact on the accuracy of the output of the neural network on which the neural network parameters or updates to the neural network parameters are applied. For example, the smallest absolute values can be the least important values and can be set to zero. In some example, the smallest absolute values can be determined by comparing the absolute values to a predetermined threshold, and setting to zero the absolute values which are less than or equal to the threshold. In some examples, the smallest absolute values can be determined as the P % smallest values, where P % is a predetermined percentage value.
Pruning of some convolutional filters. Pruning can comprise removing some of the convolutional filters, or setting the neural network parameters of some of the convolutional filters to zero.
Matrix decomposition, which would decompose one or more matrix in the neural network parameters or updates to the neural network parameters signal into multiple matrices.
Quantizing some or all of the values in the neural network parameters or updates to the neural network parameters to a lower precision representation of the values. For example, quantizing from 32 bits floating-point values to 8 bits fixed-point values. The quantizing could comprise scalar quantization, codebook-based quantization or any other suitable type of quantization.
Lossless coding, such as entropy-based coding, for example by using arithmetic coding. The lossless coding could comprise using a learned probability model for estimating the probability of the next symbol to be encoded/decoded, that would then be used by the arithmetic encoder/decoder.

The rendering device can perform a prediction of the neural network parameters or updates to the neural network parameters. In this case, the encoding device can encode a prediction residual, or prediction error, which is the difference between the neural network parameters or updates to the neural network parameters and the predicted neural network parameters or updates to the neural network parameters. The residual may be encoded using one or more of the processes, i.e., sparsification, pruning, matrix decomposition, quantization, lossless coding, etc.

In some examples the pretraining of the neural network and/or the finetuning of the neural network can be performed by using an additional term in the objective function (for example, in the loss function). This additional term can be used to enable the neural network parameters, or updates to the neural network parameters, to be more compressible. For example, the additional term can enable the neural network parameters, or updates to the neural network parameters, to have lower entropy. In some examples the additional term can enable the neural network parameters, or update to the neural network parameters, to be more robust to subsequent compression steps such as sparsification and/or quantization. In such examples, the additional term can be the L1 norm computed on the neural network parameters, or updates to the neural network parameters. This can make the neural network parameters, or updates to the neural network parameters to be more robust to sparsification. Another example for the additional term is a term that can encourages the neural network parameters or updates to the neural network parameters to be quantized or almost-quantized, so that they can be represented by lower-precision values, such as fixed-point 8 bits values instead of floating-point 32 bits values.

The neural network can have any suitable architecture such as a feedforward architecture. The feedforward architecture could comprise a multilayer perceptron network, which comprises fully-connected layers, non-linear activation functions, normalization layers or any other suitable functions and/or layers. In some examples the feedforward architecture could comprise a convolutional network, which comprises convolutional layers, non-linear activation functions, normalization layers or any other suitable functions and/or layers. In some other examples, the feedforward architecture can be based on the use of neural attention mechanisms (such as in the architecture called Transformer), where an attention mechanism may comprise assigning different weights to different parts of the input data of the neural network or to different parts of data output by intermediate layers of the neural network.

In examples where the network inputs comprise the control gains at ten octave bands and the outputs comprise the ten optimized gains for octave band filters, the network can comprise ten input nodes, twenty neurons in a single hidden layer, and ten output nodes. The sigmoid activation function can be used, for example applied on the output of each neuron of the single hidden layer. Such a network can be trained, for example, with the Bayesian regularization backpropagation to optimize the weight and bias values. Any suitable training procedure or training algorithm can be utilized for training the neural network, for example by Stochastic Gradient Descent optimizer applied on the loss function, where the gradients of the loss function with respect to the neural network parameters are obtained by the backpropagation algorithm.

In some examples the neural network can comprise a recurrent neural network architecture such as the Long Short-Term Memory (LSTM) architecture, or any variant of this, such as the convolutional LSTM, the GRU, or any other suitable architecture. Recurrent architectures can be used when temporal information about the evolution of the GEQ parameters, or other digital signal processing operation parameters can be obtained and used for improving the predictions. In some examples, a combination of one or more feedforward neural network architecture and one or more recurrent neural network architecture may be used.

It is to be appreciated that variations to these methods of training neural networks can be used in examples of the disclosure. Different examples can be used to determine the time span for which the neural network parameters or neural network parameter updates are valid and can be used by the rendering device. Time span can be a temporal range that can be mapped to a set of audio samples or audio frames:
1. The neural network parameters or updates to the neural network parameters can be valid until the next neural network parameters or updates to the neural network parameters are received/decoded.
2. The neural network parameters or updates to the neural network parameters can be valid for a specified time span. The time span can be specified for example in a high-level syntax manner.
3. The same neural network parameters or updates to the neural network parameters can be valid for multiple specified time spans which are not continuous in time. The multiple time spans can be specified for example in a high-level syntax manner.

A combination of the methods for determining or deriving the time span of a neural network can be used. Information about which method is to be used for determining or deriving the time span can be signalled from encoder to decoder within the bistream, for example by using high-level syntax.

In some examples the pretraining of the neural network can comprise pretraining a plurality of neural networks and associate each pretrained neural network with a unique identifier. At test time, the encoder could select the best performing pretrained neural network and signal only the identifier of that neural network to the rendering device. The best performing pretrained neural network could be an optimal or substantially optimal neural network.

In some examples the pretraining of the neural network can comprise pretraining a plurality of neural networks and associate each pretrained neural network with a unique identifier. At test time, the encoder could select the best performing pretrained neural network and could finetune that pretrained neural network in order to obtain a content-specific neural network parameter update. The encoder could then encode both the neural network parameter update and the identifier of the pretrained neural network on which the neural network parameter update is to be applied.

In some examples the pretraining of the neural network can comprise pretraining a single neural network and then finetuning a subset of neural network parameters such as weights to different types of contents. The subset of neural network parameters could be, for example, only the bias terms. Each subset of finetuned neural network parameters can then be associated with a unique identifier. Different types of contents can refer to, for example, reverberator attenuation filtering, reverberator diffuse-to-direct ratio filtering, material filtering, medium absorption, directivity filtering, or any other suitable type of content. At test time, the encoder could select the optimal subset of finetuned neural network parameters and signal only the identifier.

In some example the training of the neural network could comprise using an additional loss term as part of the total training loss function. The additional loss term can be designed to make the updates to the neural network parameters more compressible. For example, the additional loss term can be designed so that the neural network parameter updates have lower entropy, or has more values close to zero so that a high sparsification ratio (many zero values after sparsification operation) can be achieved. The additional loss term can be associated with a scalar multiplier which determines how much the additional loss impacts the training or finetuning process at the encoder. The total training loss can therefore comprise a weighted sum, where each loss term is weighted by a scalar multiplier. The scalar multipliers can be predetermined or determined via a search algorithm, such as grid search.

In some examples a pretrained neural network can be finetuned by the rendering device at test time instead of being finetuned by the encoder. In such examples the pairs of input data and the sensed input data can be available to the rendering device.

FIG. 11 schematically shows an example rendering device 1100 that can be provided in some examples of the disclosure. The rendering device 1101 can be any device comprising any means that can enable audio content to be rendered for playback to a user 111.

The rendering device 1100 comprises means for receiving an input signal 1101. The input signal 1101 can comprise audio content. The audio content can be received via an encoded bitstream. The bitstream can be decoded before the input signal 1101 is provided to the rendering device 1100.

The rendering device 1100 comprises one or more delay lines 1103. The delay lines 1103 can comprise any means for introducing a delay into the input signal. The rendering device 1100 is configured so that the input signal 1101 is provided to the one or more delay lines 1103. The one or more delay line 1103 introduces delays to account for direct sound and early reflections.

The one or more delay lines 1103 provide a plurality of output that are then provided to a plurality of filters 1105. The plurality of filters 1105 comprise any means that can be configured to process the audio signals to account for parameters such as source directivity, distance/gain attenuation, material types or any other acoustic effects. The plurality of filters 1105 can comprise graphic EQ filters whose digital signal processing operation parameters can be obtained in the bitstream (in cases where the target response known) or derived using the neural network (in cases where the target response is known only during runtime). Acoustic effects such as material attenuation and medium attenuation can be implemented with these filters 1105.

The outputs of the filters 1105 are provided to a plurality of HRTF (head related transfer function) filters 1107. The HRTF filters 1107 can comprise any means that enable the binauralization of the output of the rendering device 110. The binauralization comprises rendering the audio content to provide spatial effects suitable for a user 111 using headphones or earpieces. The HRTF filters 1107 provide two outputs. A first output is provided for a left headphone and a second output is provided for a right headphone.

At least one of the outputs of the filters 1105 can also be provided to the reverberator 1109. The reverberator 1109 can comprise any means that can be configured to add reverberation to the audio content. In some examples the reverberator 1109 can comprise a feedback delay network 301 as shown in FIG. 3. Other types of digital signal operation could be used in other examples of the disclosure.

In the example of FIG. 11 the reverberator 1109 obtained reverberation parameters 1111. The reverberation parameters 1111 comprise the parameters of the feedback delay network 301, or other digital signal processing operation, that can be used to obtain a target response. For example, the reverberation parameters 1111 can comprise coefficients for the attenuation filters 311 or any other suitable parameters.

The reverberation parameters 1111 are used to configure the reverberator 1109 to enable the reverberator 1109 to provide the target response.

In the example of FIG. 11 a reverberator 1109 is used. It is to be appreciated that other digital signal processing operations could be used in other examples of the disclosure.

The training of the neural networks and the parameters obtained after this training could be used to control the parameters of the reverberator 1109 and/or any of the other filters in the rendering apparatus 1100.

FIG. 12 shows an example system 1200 that can be provided in some examples of the disclosure. The system 1200 could be used to implement any of the example methods shown in FIGS. 2 and 4 to 10.

The system 1200 receives encoder input data 1201. The encoder input data 1201 can comprise virtual space description data 1203 and/or audio signals 1205 and/or any other suitable data that enables the spatial rendering of audio content. The virtual space description data 1203 can comprise data relating to physical properties of the virtual space 1203. For example, it can comprise data relating to the dimensions of the virtual space or the acoustic properties of the virtual space or any other suitable parameters. The audio signals 1205 can comprise the audio content.

The system 1200 comprises one or more encoders 1207. The encoders 1270 can comprise any means for processing the encoder input data 1201 to generate a bitstream 1225.

The encoder 1207 can comprise one or more modules for obtaining neural network parameters for updating neural networks and/or digital signal processing operation parameters for digital signal processing operations. The encoder 1207 can be configured so that the neural network parameters and/or parameters digital signal processing operation parameters can be encoded into the bitstream 1225.

The encoder 1207 can comprise possible target response forming module 1209. The possible target response forming module 1209 can be used when the target response is not known. The possible target response forming module 1209 can comprise any means that can be configured to form a plurality of possible target responses.

The output of the possible target response forming module 1209 can be provided as an input to a filter gain optimization module 1211. The filter gain optimization modules 1211 can comprise any means that can be configured to optimize, or substantially optimize the filter gains. It is to be appreciated that other digital signal processing operations parameters could be used in other examples of the disclosure. The filter gain optimization module 1211 can be controlled by one or more neural networks.

The filter gains obtained by the filter gain optimization module 1211 can be compared to a reference filter gain optimization by a reference module 1213.

In examples where the encoder 1207 trains the neural network the filter gains from the filter gain optimization module 1211 and the reference filter gains from the reference modules 1213 can be provided to a filter coefficient calculation module 1221. The filter coefficient calculation module 1221 can be configured to determine an error in the filter gains from the filter gain optimization module 1211 and use this error to calculate coefficients for GEQ filters. Other digital signal processing operation parameters for other digital signal processing operations could be used in other examples of the disclosure.

The calculated coefficients for the GEQ filters are provided to a GEQ response calculation module 1219. The GEQ response calculation module 1219 calculates the target response that could be obtained with the new coefficients for the GEQ filters. The calculated GEQ response can then be provided a neural network weight updating module 1217. The neural network weight updating module 1217 can be configured to determine new neural network parameters for the neural network. These can be used to control the filter gain optimization module 1211 and/or can be encoded into the bitstream 1223 and signaled to the rendering device 1239.

The encoder 1207 can also comprise a known target response forming module 1215. The known target response forming module 1215 can be used when the target response is known. The known target response can enable reference filter gains to be obtained by the reference module 1213.

The encoder 1207 also comprises a bitstream encoding module 1223. The bitstream encoding module 1223 can comprise any means for encoding the data that is to be sent to the rendering device 1227. In the example of FIG. 12 the encoder 1207 can be configured to encode the audio signals, the gains for the GEQ filters, the weight updates for the neural networks or any other suitable data.

The bitstream, 1225 can be transmitted from the encoder 1207 to the rendering device 1227. The rendering device 1227 can comprise any means configured to decode the received bitstream 1225 and enable the decoded audio content to be rendered for playback to a user 111.

In the example of FIG. 12 the rendering device 1227 comprises a bitstream decoding module 1220 that is configured to decode the bitstream.

The rendering device 1227 comprises a neural network weight update module 1235. The neural network weight update module 1235 can be configured to receive the data for updating the neural network from the decoding modules 1229. The weight updates can then be provided as an input to a filter gain optimization module 1233. The filter gain optimization modules 1233 can comprise any means that can be configured to optimize, or substantially optimize the filter gains. It is to be appreciated that other digital signal processing operation parameters of other digital signal processing operations could be used in other examples of the disclosure. The filter gain optimization module 1233 can be controlled by one or more neural networks that can be updated as needed with the data from the bitstream.

The filter gain optimization module 1233 also receives an input from a reverberator parameter derivation module 1231. The reverberator parameter derivation module 1231 comprises any means that can be configured to derive the reverberation parameters. The reverberation parameters can receive one or more sensing inputs 1253 to enable the reverberation parameters to be derived. For example, the sensing inputs 1253 could comprise measurements of the room the user is located in or any other suitable information. The reverberator parameter derivation module 1231 can be used to determine the reverberator parameters for augmented reality applications based on the measurements of the room and/or any other suitable information such as an impulse response of the room or its reverberation characteristics. It is to be appreciated that in other examples parameters for other acoustic effects could be determined.

The filter gain optimization module 1233 also receives an input from a composite response forming module 1249. The composite response forming module 1249 receives inputs relating to directivity 1243, material absorption 1245 and medium attenuation 1247 and uses this to form a composite response. The inputs relating to directivity 1243, material absorption 1245 and medium attenuation 1247 can be obtained from the decoded bitstream.

The outputs from the filter gain optimization module 1233 can be provided to a filter coefficient calculation module 1237. The filter coefficient calculation module 1237 can be configured to calculate coefficients for GEQ filters. Other digital signal processing operation parameters for other digital signal processing operations could be used in other examples of the disclosure.

The outputs from the filter coefficient calculation module 1237 are provided to a GEQ filtering module 1241 to enable filtering of the audio content from the bitstream. The GEQ filtering module can also receive an input from reverberation rendering module 1239. The reverberation rendering module can obtain an input from the reverberator parameter derivation module 1231 so as to enable the reverberation rendering to be determined.

The output of the GEQ filtering module 1241 can then be provided a spatialization module 1251 to enable spatialization of the audio. Spatialization could comprise binauralization using one or more HRTFs or any other suitable spatialization process.

FIG. 13 schematically illustrates an apparatus 101 according to examples of the disclosure. The apparatus 1301 illustrated in FIG. 13 may be a chip or a chip-set. In some examples the apparatus 1301 may be provided within devices such as a processing device. In some examples the apparatus 1301 may be provided within an audio capture device or an audio rendering device.

In the example of FIG. 13 the apparatus 1301 comprises a controller 1303. In the example of FIG. 13 the implementation of the controller 1303 may be as controller circuitry. In some examples the controller 1303 may be implemented in hardware alone, have certain aspects in software including firmware alone or can be a combination of hardware and software (including firmware).

As illustrated in FIG. 13 the controller 1303 may be implemented using instructions that enable hardware functionality, for example, by using executable instructions of a computer program 1309 in a general-purpose or special-purpose processor 1305 that may be stored on a computer readable storage medium (disk, memory etc) to be executed by such a processor 1305.

The processor 1305 is configured to read from and write to the memory 1307. The processor 1305 may also comprise an output interface via which data and/or commands are output by the processor 1305 and an input interface via which data and/or commands are input to the processor 1305.

The memory 1307 is configured to store a computer program 1309 comprising computer program instructions (computer program code 1311) that controls the operation of the apparatus 1301 when loaded into the processor 1305. The computer program instructions, of the computer program 1309, provide the logic and routines that enables the apparatus 1301 to perform the methods illustrated in FIGS. 2 and 4 to 10. The processor 1305 by reading the memory 1307 is able to load and execute the computer program 1309.

The apparatus 1301 therefore comprises: at least one processor 1305; and at least one memory 1307 including computer program code 1311, the at least one memory 107 and the computer program code 1311 configured to, with the at least one processor 1305, cause the apparatus 1301 at least to perform:
obtaining (201) audio content representing at least one audio space;
enabling at least one digital signal processing operation to render the audio content such that the rendered audio content comprises at least one target response for the at least one audio space wherein the enabling of the at least one digital signal processing operation to render the audio content is controlled based on;
obtaining (203) the at least one target response for the at least one audio space; and
obtaining (207) at least one parameter for the at least one digital signal processing operation, when the obtained target response is known, and using the obtained at least one parameter to enable the at least one digital signal processing operation to reproduce (209) an acoustic effect with the target response for a user position within the at least one audio space; or
obtaining (211) at least one parameter for a neural network when the obtained target response is unknown, and using the neural network to determine (213) at least one parameter for the at least one digital signal processing operation, and using the at least one determined parameter to enable the at least one digital signal processing operation to reproduce (209) an acoustic effect with the target response for the user position within the at least one audio space.

As illustrated in FIG. 13 the computer program 1309 may arrive at the apparatus 1301 via any suitable delivery mechanism 1313. The delivery mechanism 1313 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1309. The delivery mechanism may be a signal configured to reliably transfer the computer program 1309. The apparatus 1301 may propagate or transmit the computer program 1309 as a computer data signal. In some examples the computer program 1039 may be transmitted to the apparatus 1301 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 1309 comprises computer program instructions for causing an apparatus 1301 to perform at least the following:
obtaining (201) audio content representing at least one audio space;
enabling at least one digital signal processing operation to render the audio content such that the rendered audio content comprises at least one target response for the at least one audio space wherein the enabling of the at least one digital signal processing operation to render the audio content is controlled based on;
obtaining (203) the at least one target response for the at least one audio space; and
obtaining (207) at least one parameter for the at least one digital signal processing operation, when the obtained target response is known, and using the obtained at least one parameter to enable the at least one digital signal processing operation to reproduce (209) an acoustic effect with the target response for a user position within the at least one audio space; or
obtaining (211) at least one parameter for a neural network when the obtained target response is unknown, and using the neural network to determine (213) at least one parameter for the at least one digital signal processing operation, and using the at least one determined parameter to enable the at least one digital signal processing operation to reproduce (209) an acoustic effect with the target response for the user position within the at least one audio space.

The computer program instructions may be comprised in a computer program 1309, a non-transitory computer readable medium, a computer program product, a machine readable medium. In some but not necessarily all examples, the computer program instructions may be distributed over more than one computer program 1309.

Although the memory 1307 is illustrated as a single component/circuitry it may be implemented as one or more separate components/circuitry some or all of which may be integrated/removable and/or may provide permanent/semi-permanent/dynamic/cached storage.

Although the processor 1305 is illustrated as a single component/circuitry it may be implemented as one or more separate components/circuitry some or all of which may be integrated/removable. The processor 1305 may be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the FIGS. 2 and 4 to 10 can represent steps in a method and/or sections of code in the computer program 1309. The illustration of a particular order to the blocks does not necessarily imply that there is a required or preferred order for the blocks and the order and arrangement of the block may be varied. Furthermore, it can be possible for some blocks to be omitted.

In this description the term coupled means operationally coupled. Any number or combination of intervening elements can exist between coupled components including no intervening elements.

The above described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus comprising:
at least one processor; and
at least one non-transitory memory storing instructions that, when executed with the at least one processor, cause the apparatus at least to:
obtain audio content representing at least one audio space;
enable at least one digital signal processing operation to render the audio content such that the rendered audio content comprises at least one target response for the at least one audio space, wherein the enabling of the at least one digital signal processing operation to render the audio content is controlled based on obtaining the at least one target response for the at least one audio space; and
obtaining at least one parameter for the at least one digital signal processing operation, when the obtained target response is known, and using the obtained at least one parameter to enable the at least one digital signal processing operation to reproduce an acoustic effect with the target response for a user position within the at least one audio space; or
obtaining at least one parameter for a neural network, when the obtained target response is unknown, and using the neural network to determine at least one parameter for the at least one digital signal processing operation, wherein the determined at least one parameter enables the at least one digital signal processing operation to reproduce an acoustic effect with the target response for the user position within the at least one audio space.

2. An apparatus as claimed in claim 1, wherein the digital signal processing operation comprises one or more filterbanks and the at least one obtained parameter comprises one or more filterbank gains.

3. An apparatus as claimed in claim 2, wherein the instructions, when executed with the at least one processor, cause the apparatus to use the filterbank to perform one or more of reverberator attenuation filtering, reverberator diffuse-to-direct ratio control, directivity filtering, material attenuation, or medium absorption filtering.

4. An apparatus as claimed in claim 3, wherein the filterbank comprises a graphic equalizer filterbank.

5. An apparatus as claimed in claim 1, wherein the target response comprises target control gains for an output audio signal to enable an audio scene to be rendered to a user based on the user position within the at least one audio space.

6. An apparatus as claimed in claim 1, wherein the instructions, when executed with the at least one processor, cause the apparatus to at least one of:
receive one or more acoustic effect parameters; or
enable the one or more acoustic effect parameters, wherein the neural network is used to obtain the parameters for the at least one digital signal processing operation.

7. An apparatus as claimed in claim 1, wherein the one or more acoustic effect parameters comprise information indicative of the at least one target response for an audio signal.

8. An apparatus as claimed in claim 1, wherein the instructions, when executed with the at least one processor, cause the apparatus to at least one of:
receive one or more parameters for the neural network;
use the parameters for the neural network to generate the neural network; or
obtain the parameters for the digital signal processing operation.

9. An apparatus as claimed in claim 8, wherein the one or more parameters for the neural network are received from an encoding device.

10. An apparatus as claimed in claim 1, wherein the instructions, when executed with the at least one processor, cause the apparatus to at least one of:
receive information indicative of one or more weights for the neural network;
use the information indicative of one or more weights for the neural network to adjust the neural network; or
use the adjusted neural network to obtain the parameters for the digital signal processing operation.

11. An apparatus as claimed in claim 10, wherein the information indicative of one or more weights for the neural network comprises at least one of: one or more values for one or more weights of the neural network; or one or more references to a stored set of weights for the neural network.

12. An apparatus as claimed in claim 1, wherein the instructions, when executed with the at least one processor, cause the apparatus to at least one of:
update one or more weights for the neural network;
use the updated weights to adjust the neural network; or
use the adjusted neural network to obtain the parameters for the digital signal processing operation.

13. An apparatus as claimed in claim 1, wherein the instructions, when executed with the at least one processor, cause the apparatus to determine a position of a user within the at least one audio space.

14. An apparatus as claimed in claim 1, wherein the instructions, when executed with the at least one processor, cause the apparatus to provide a binaural audio output.

15-16. (canceled)

17. A method, comprising:
obtaining audio content representing at least one audio space;
enabling at least one digital signal processing operation to render the audio content such that the rendered audio content comprises at least one target response for the at least one audio space wherein the enabling of the at least one digital signal processing operation to render the audio content is controlled based on obtaining the at least one target response for the at least one audio space; and
obtaining at least one parameter for the at least one digital signal processing operation, when the obtained target response is known, and using the obtained at least one parameter enable the at least one digital signal processing operation to reproduce an acoustic effect with the target response for a user position within the at least one audio space; or
obtaining at least one parameter for a neural network, when the obtained target response is unknown, and using the neural network to determine at least one parameter for the at least one digital signal processing operation, wherein the determined at least one parameter enables the at least one digital signal processing operation to reproduce an acoustic effect with the target response for the user position within the at least one audio space.

18. A method as claimed in claim 17 wherein the digital signal processing operation comprises one or more filterbanks and the at least one obtained parameter comprises one or more filterbank gains.

19. A non-transitory program storage device readable with an apparatus, tangibly embodying a program of instructions executable with the apparatus for performing:
obtaining audio content representing at least one audio space;
enabling at least one digital signal processing operation to render the audio content such that the rendered audio content comprises at least one target response for the at least one audio space wherein the enabling of the at least one digital signal processing operation to render the audio content is controlled based on obtaining the at least one target response for the at least one audio space; and
obtaining at least one parameter for the at least one digital signal processing operation, when the obtained target response is known, and using the obtained at least one parameter enable the at least one digital signal processing operation to reproduce an acoustic effect with the target response for a user position within the at least one audio space; or
obtaining at least one parameter for a neural network, when the obtained target response is unknown, and using the neural network to determine at least one parameter for the at least one digital signal processing operation, wherein the determined at least one parameter enables the at least one digital signal processing operation to reproduce an acoustic effect with the target response for the user position within the at least one audio space.

20-21. (canceled)

22. An apparatus as claimed in claim 1, wherein the apparatus is at least one of:
an audio rendering device; or
an encoding device.

23. A method as claimed in claim 17, wherein the digital signal processing operation comprises one or more filterbanks and the at least one obtained parameter comprises one or more filterbank gains.

24. A method as claimed in claim 17, wherein the one or more filterbank is configured to perform one or more of reverberator attenuation filtering, reverberator diffuse-to-direct ratio control, directivity filtering, material attenuation, or medium absorption filtering.

25. A method as claimed in claim 17, comprising at least one of:
receiving one or more parameters for the neural network;
using the parameters for the neural network to generate the neural network; or
obtaining the parameters for the digital signal processing operation.
